(19) United States
(12) Patent Application Publication
(10) Pub. No.: US 2024/0119695 A1
(43) Pub. Date: Apr. 11, 2024

(54) GENERATION OF EMPHASIS IMAGE WITH EMPHASIS BOUNDARY

(71) Applicant: Microsoft Technology Licensing, LLC, Redmond, WA (US)

(72) Inventor: Salman Muin Kayser CHISHTI, Tallinn (EE)

(21) Appl. No.: 17/960,603

(22) Filed: Oct. 5, 2022

(51) Int. Cl. G06V 10/25; G06T 5/00; G06T 7/11; G06T 7/13; G06V 10/70; G06V 20/70

(52) U.S. Cl. CPC G06V 10/25; G06T 5/002; G06T 7/11; G06T 7/13; G06V 10/70; G06V 20/70; G06T 2207/20081; G06T 2207/20132

(57) ABSTRACT

The automated generation of an emphasis image (such as a cropped image) that is based on an input image. The input image is fed to a machine-learned model that is trained to label portions of images. That machine-learned model then outputs an identification of multiple portions of images, along with potentially labels of each of those identified portions. The label identifies a property of the corresponding identified portion. As an example, one portion might be labelled as irrelevant, another might be labelled as a name, another might be labelled as a comment, and so forth. That output is accessed and the generated label is used to determine an emphasis bounding box. The emphasis bounding box is then applied to the input image to generate an emphasis image. As an example, the emphasis image may be a cropped image of the input image.

### BACKGROUND

Computing systems often present a visual to a user on a display. Such displayed visuals are often termed a “user interface”. The user interface may include for example, a frame, a window, or perhaps even an entire screen of displayed content. When a user interface is suboptimal or has a defect, a user may take a screenshot of the user interface, and send that screenshot along with a description of the problem to an entity, such as an Information Technology (IT) representative who can take care of the problem. On a larger scale, there may be distributed systems in an organization that allow its users to issue reports that include screenshots and problem descriptions to a central point, where the reports are distributed to other to appropriately evaluate and remedy the problem.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments described herein involve the automated generation of an emphasis image (such as a cropped image) that is based on an input image. The input image is fed to a machine-learned model that is trained to label portions of images. That machine-learned model then outputs an identification of multiple portions of the input image, potentially along with labels of each of those identified portions. The label identifies a property of the corresponding identified portion. As an example, one portion might be labelled as irrelevant, another might be labelled as a name, another might be labelled as a comment, and so forth.

That output is accessed and the generated label is used to determine an emphasis boundary (such as an emphasis bounding box). The emphasis bounding box is then applied to the input image to generate an emphasis image. As an example, the emphasis image may be a cropped image of the input image. The described embodiments thus allow for an automated generation of an emphasis image that emphasizes only a certain portion of the original image. In the case of cropping, the described embodiments enable the image to be automatically cropped. As an example, suppose that a user is reporting a defect in a user interface along with user-entered feedback. The input image and the user-entered feedback may be used to crop out portions of the image that are not relevant to the feedback. Thus, the area needed to store the image is reduced, and the reader of that feedback may be given a user interface snippet that is much more tailored to the problem, allowing for faster assessment and resolution of the problem.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1A illustrates an input image that has boundaries and that illustrates objects symbolically represented as different sized circles, and is used as a mere example input image for discussion purposes in explaining subsequent figures;

FIG. 1B illustrates an emphasis image that is based on the input image of FIG. 1A;

FIG. 2 illustrates a flowchart of a method for generating an emphasis image, in accordance with the principles described herein;

FIG. 3 illustrates an environment in which the method of FIG. 2 may be performed, and that includes an emphasis image generation system that performs the method of FIG. 2 using a machine-learned model, in accordance with the principles described herein;

FIG. 4 illustrates an example of the model output in the form of four portion identifiers, and in which those portion identifiers are represented by their position in the input image of FIG. 1A;

FIG. 5 illustrates an environment that is similar to the environment 300 described above with respect to FIG. 3, except that instead of a single machine-learned model, the environment includes multiple machine-learned models each trained on labelled user interfaces of a respective user interface type;

FIG. 6 illustrates a mechanism for selecting a machine-learned model based on a user interface type that the input image conforms to, in accordance with the principles described herein; and

FIG. 7 illustrates an example computing system in which the principles described herein may be employed.

### DETAILED DESCRIPTION

Embodiments described herein involve the automated generation of an emphasis image (such as a cropped image) that is based on an input image. The input image is fed to a machine-learned model that is trained to label portions of images. That machine-learned model then outputs an identification of multiple portions of the input image, potentially along with labels of each of those identified portions. The label identifies a property of the corresponding identified portion. As an example, one portion might be labelled as irrelevant, another might be labelled as a name, another might be labelled as a comment, and so forth.

That output is accessed and the generated label is used to determine an emphasis boundary (such as an emphasis bounding box). The emphasis bounding box is then applied to the input image to generate an emphasis image. As an example, the emphasis image may be a cropped image of the input image. The described embodiments thus allow for an automated generation of an emphasis image that emphasizes only a certain portion of the original image. In the case of cropping, the described embodiments enable the image to be automatically cropped. As an example, suppose that a user is reporting a defect in a user interface along with user-entered feedback. The input image and the user-entered feedback may be used to crop out portions of the image that are not relevant to the feedback. Thus, the area needed to store the image is reduced, and the reader of that feedback may be given a user interface snippet that is much more tailored to the problem, allowing for faster assessment and resolution of the problem.

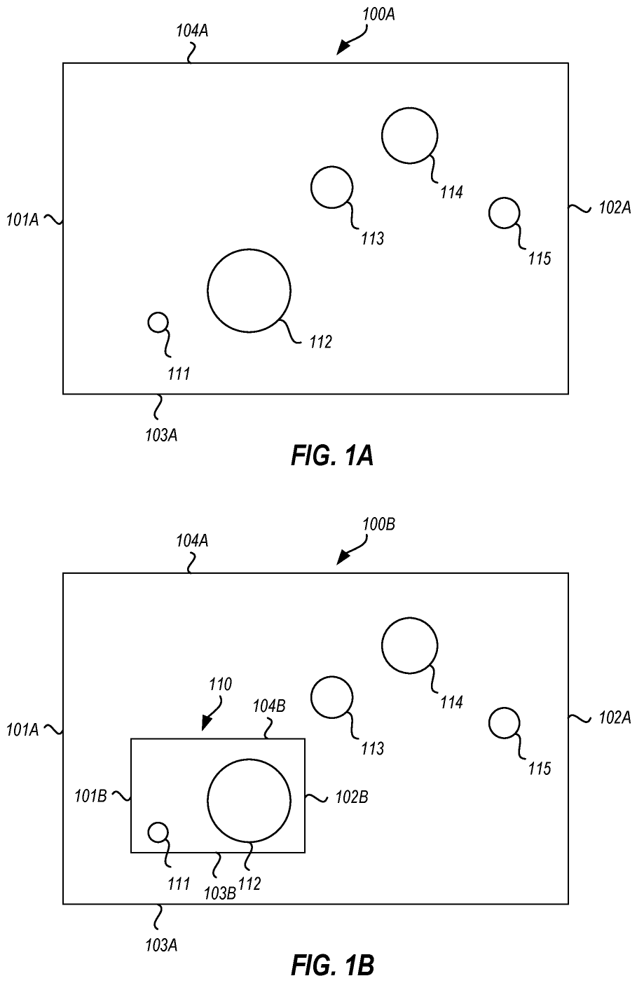

Embodiments described herein relate to the generation of an emphasis image based on an input image. As an example, FIG. 1A illustrates an input image 100A that has boundaries 101A, 102A, 103A and 104A. FIG. 1B illustrates an emphasis image 100B that is based on the input image 100A, but which also has an emphasis boundary 110 represented by boundaries 101B, 102B, 103B and 104B.

The principles described herein are not limited to what the input image 100A actually depicts. Examples include text boxes, names, windows, chat screens, camera output, faces, and any other item that can be visually represented. For example purposes, there are five items 111 through 115 that are illustrated as being depicted in the input image 100A. For simplicity, the items 111 through 115 are each represented simply as different sized circles, but of course, the depicted items could be anything that can be visualized in an image. Furthermore, the input image 100A may visually depict any number of items.

The emphasis image 100B emphasizes the portion of the image 100A inside of the emphasis boundary 110. Here, the emphasis boundary 110 includes the depicted items 111 and 112, but not the items 113 through 115. In one embodiment, this emphasis is performed by cropping the image outside of the emphasis boundary 110. In that case, the emphasis boundary is a cropping boundary. In such a case, the emphasis image 100B is only the portion of the image 100A that is within the emphasis boundary 110. Alternatively, the content within the emphasis boundary 110 is emphasized by blurring, blackening, or pixelating the portion of the image outside of the emphasis boundary 110.

In any of these cases, the size in bits of the emphasis image 100B is smaller compared to the input image 100A. Accordingly, storage and memory resources are preserved when storing the emphasis image 100B as compared to the input image 100A. Furthermore, the emphasis image 100B is helpful as it draws the attention of the viewer into the emphasis boundary 110. For example, the attention of the viewer is drawn to the depicted items 111 and 112 within the emphasis boundary 110.

The example input image 100A and emphasis image 100B will be referred to hereinafter by way of example only. However, the principles described herein apply regardless of the shape or size of each of the input image 100A, the emphasis image 100B, and boundary 110, regardless of the shape, size or position of the boundary 110, and regardless of what the input image depicts. That said, the boundary 110 is preferably rectangular since its shape, size and position can be compactly represented in data, and the deemphasis or cropping of the portion of the image outside of the boundary 110 becomes less processing intensive.

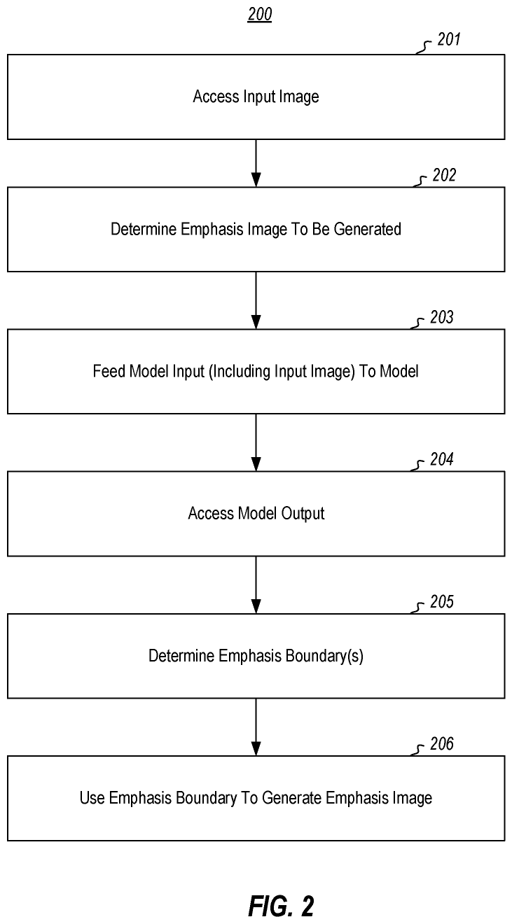

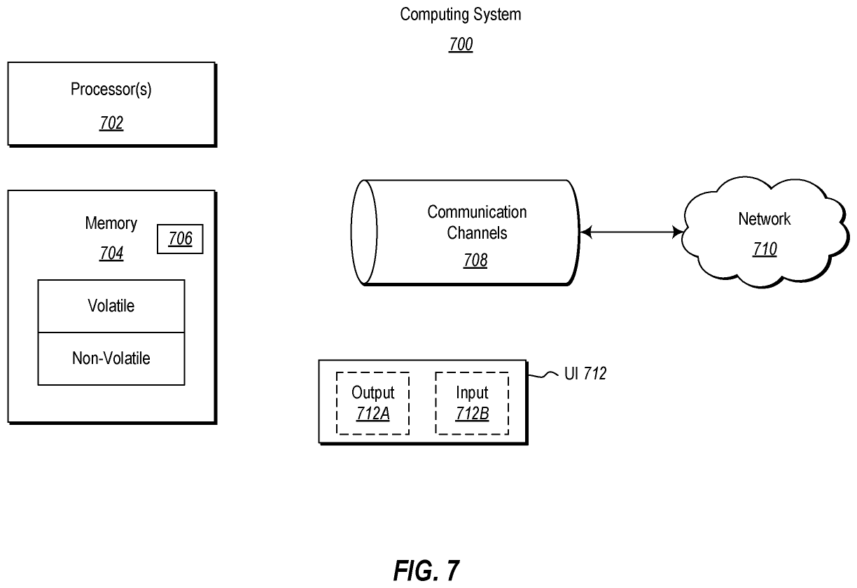

FIG. 2 illustrates a flowchart of a method 200 for generating an emphasis image, in accordance with the principles described herein. The method 200 will be described with frequent reference to the example input image 100A of FIG. 1A and the example emphasis image 100B of FIG. 1B. The method 200 is performed by a computing system, such as the computing system 700 described below with respect to FIG. 7. In one embodiment, the computing system has one or more computer-readable media (such as one or more computer storage media) that has stored thereon computer-executable instructions that are structured such that, if executed by the one or more processors 702 of the computing system 700, the computing system 700 is caused to perform the method 200.

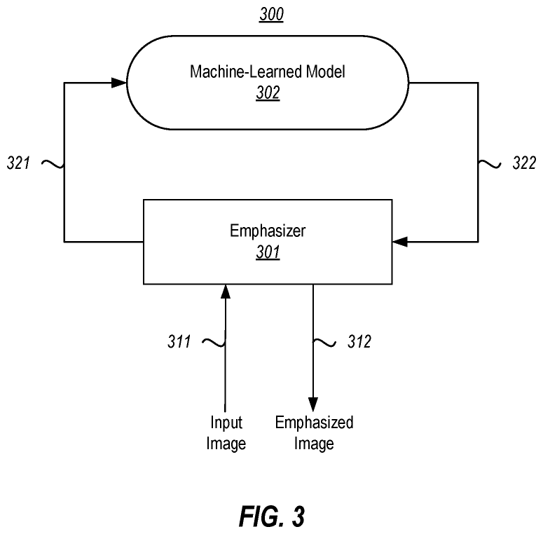

FIG. 3 illustrates an environment 300 in which the method 200 may be performed. Specifically, the environment 300 includes an emphasis image generation system 301 that performs the method 200, and a machine-learned model 302 that helps to label portions of the input image to facilitate the generation of the emphasis image. As an example, the emphasis image generation system 301 may be the computing system 700 of FIG. 7 that performs the method 200 of FIG. 2. For short, the emphasis image generation system 301 may also be referred to as the “emphasizer” or the “emphasizer 301”.

The method 200 includes accessing an input image (act 201), and determining that an emphasis image is to be generated based on the input image (act 202). As an example, the emphasizer 301 of FIG. 3 may access the input image 100A of FIG. 1A. In FIG. 3, the act of the emphasizer 301 accessing an input image is represented by arrow 311.

The method 200 then includes feeding the input image to a machine-learned model that is trained to label portions of images (act 203). The input image may be fed, along with potentially other input, to the machine-learned model. As an example, in the environment 300 of FIG. 3, the emphasizer 301 provides (as represented by arrow 321) model input to the machine-learned model 302. Again, such model input includes the input image as well as potentially other model input.

As a result, the machine-learned model will output an identification of portions of the input image, in which some or all of the identified portions are labelled. Such a collection of output will also be referred to as the “model output”. In the example of FIG. 3, the machine-learned model 302 outputs (as represented by arrow 322) the model output. In addition, this output may also include a structured text object, such as perhaps JSON or XML, the couples the identification of image portions with the corresponding labels. That structured text object may be filtered so as to remove personally identifiable information, or otherwise confidential, sensitive, and/or personal information.

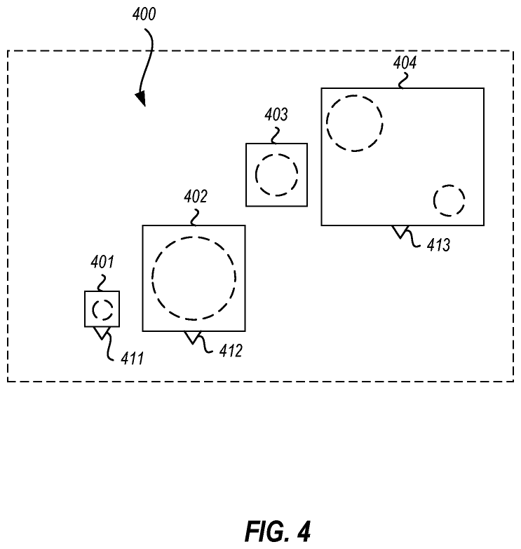

FIG. 4 illustrates an example of the model output 400 in the form of four portion identifiers 401 through 404. The portion identifiers 401 through 404 each identify where in the input image the corresponding portion is found. To represent this in FIG. 4, the portion identifiers 401 through 404 are shown with respect to the overall boundaries of the input image (represented in dashed-lined form), and the corresponding objects (represented in dotted-lined form), to represent that the model output does not include the input image itself, but does including portion identifiers that identify the bounds in which the corresponding portion appears in the input image.

As symbolized by triangles 411 through 413, some or all of the portion identifiers may also include labels generated by the machine-learned model. For example, portion identifier 401 has label 411, portion identifier 402 has label 412, and portion identifier 404 has label 413. Portion identifier 403 does not have a label to emphasize that the principles described herein do not require that all of the portions identified by the machine-learned model have to have a label assigned by the machine-learned model.

An image portion of the input image that is identified by the machine-learned model will be referred to herein also as an “identified portion”. An identified portion that is also labelled by the machine-learned model will be referred to herein also as a “labelled portion”. A labelled portion may have a single label generated by the machine-learned model, but may also have multiple labels generated by the machine-learned model.

Returning to the method 200, the emphasizer accesses the model output of the machine-learned model (act 204). Referring to FIG. 3, the emphasizer 301 accesses (as represented by arrow 322) the model output. The emphasizer then uses a labelled portion of the multiple labelled portions of the input image to determine an emphasis boundary (act 205), which may be for instance a rectangular bounding box. As an example, suppose that the emphasizer 301 fed the input image 100A to the machine-learned model 302, which resulted in the machine-learned model generating the model output 400 of FIG. 4. The emphasizer might for example determine from the label 411 of the labelled portion 401, and the label 412 of the labelled portion 402, and the label 413 of the labelled portion 404, that the boundary is to include the portions 401 and 402 only. In that case, the emphasizer may establish an emphasis boundary at the position corresponding to the emphasis boundary 110 of FIG. 1B.

The emphasizer then applies the emphasis boundary to the input image to generate the emphasis image (act 206). For instance, with reference to FIG. 3, the emphasizer 301 may generate an emphasis image as represented by arrow 312. With reference to FIG. 1B, the emphasizer may generate the emphasis image 100B by cropping, pixelating, blackening, blurring or otherwise deemphasizing outside of the emphasis boundary 110 and emphasizing inside of the emphasis boundary 110.

As previously mentioned with respect to act 205, the emphasizer uses a labelled portion of the multiple labelled portions of the input image to determine an emphasis boundary (act 205). More generally speaking, the emphasizer may use any of multiple labelled portions of the input image to determine the emphasis boundary. The labels of the labelled portions are used to determine what is appropriate to emphasize and what is appropriate to deemphasize.

As an example, suppose that the label is “confidential”. If the emphasizer is to make sure no confidential information is provided in the emphasized image, the emphasizer will set the emphasis boundary so that the corresponding identified portion is excluded. Thus, the portion may be labelled with a property (such as sensitivity) of the content.

Alternatively or in addition, the label may also represent a content type of the portion. For instance, suppose that the label is “name”, which represents that the portion includes a name of a person. The emphasizer may be configured to determine that names should not be included within the emphasized image. Accordingly, the emphasizer may set the emphasis boundary so that the identified portion labelled with “name” is not within the emphasis boundary. As a further example, if the label is “e-mail address”, the emphasizer may likewise set the emphasis boundary to exclude the corresponding portion. As another example, the label may be “person image” representing that the portion includes a picture of a person. The emphasizer may be programmed to exclude images of people from the emphasized portion of the emphasis image. Thus, privacy and confidentiality of information that was included in the input image may be preserved through elimination of such sensitive information from the emphasis image.

A label may also include a label of the relevance of the portion as applied to the objective of the emphasizer. As an example, suppose the emphasizer is to provide a snippet of a user interface that is most relevant to user-entered feedback (such as a bug report). In that case, the machine-learned model may be trained on example user-entered feedback, so as to train the machine-learned model to provide an appropriate relevance label to each of multiple portions based on model input in the form of the input image and the user-entered feedback. Alternatively, or in addition to the user-entered feedback, a log representing activity of the entity that caused the user interface to be generated may also be provided to the machine-learned model to provide an appropriate relevance label.

Alternatively, or in addition, the emphasizer may be configured to itself determine relevance of each portion based on labels that identify content. As an example, if the emphasizer determines that the user-entered feedback is with respect to a defect or user-perceived problem in a “submit button”, the emphasizer may make sure that portions labelled with labels that specify or generally indicate the submit button are included within the emphasis boundary and/or that portions labelled as irrelevant are not included within the emphasis boundary. Thus, the principles described herein may be practiced in a bug reporting system to provide focused images relevant to problem reports, allowing bugs and user interface defects to be properly addressed. Alternatively, or in addition to the user-entered feedback, a log representing activity of the entity that caused the user interface to be generated may also be used by the emphasizer to determine whether a portion is relevant.

In this example, the input image is a still image. However, the principles described herein may alternatively be performed with a video image. In that case, the machine-learned model may perform the labelling on different still images of the video image, thereby repeatedly outputting identified portions, and labelled portions. In this case, the emphasis boundary may move from frame to frame in the video image. In one example, a security system may provide video to the machine-learned model, and the emphasizer may focus on those portions of the video that are most relevant to security concerns.

Accordingly, embodiments described herein provide an effective and automated mechanism for generating an emphasis image from an input image to allow for more focused representation of content within the emphasis boundary. This allows for a reduced size of the image thereby reducing storage and memory requirements, while still retaining the image portions of relevance. Furthermore, where the input image contains sensitive information, that emphasis image may be generated so as to remove that sensitive data. For instance, even if the confidential or sensitive portions are within the emphasis boundary, those sensitive portions may still be visually obscured so that the information from those portions cannot be ascertained. The obscured portions may be compressed with a higher compression ratio, thereby further reducing storage and memory requirements for the emphasis image. Thus, privacy and confidentiality are properly preserved while also preserving storage and memory.

In the above description with respect to FIG. 3, an emphasizer 301 provides model input to a machine-learned model 302 and accessing resulting output from the machine-learned model 302. However, in some embodiments, there may be multiple machine-learned models that each specific to a user interface type. That user interface type may be particular to a specific application, application version, a context within that application version, screen size, and so forth. The user interface type could thus correspond to a combination of one or more of an application identity, a version identity, application context identity, and screen size identity. As an example, there may be one machine-learned model that is trained on image data from a chat window of a particular version of a particular application, another machine-learned model that is trained on image data from a whiteboard window of the particular version of the particular application and so forth.

This simplifies the training of the machine-learned model. For instance, someone familiar with a particular user interface type may, for each of a few example user interface of that user interface type, label portions of the user interface. They may for instance, put a box around different portions and label those portions with perhaps an identification of what the portion is (e.g., a name) or a particular characteristic or property of the portion (e.g., irrelevant). By separating the machined-learned model by user interface type in which the layouts are similar within a given user interface type, the machine-learned model can be trained much more quickly with fewer user interface examples.

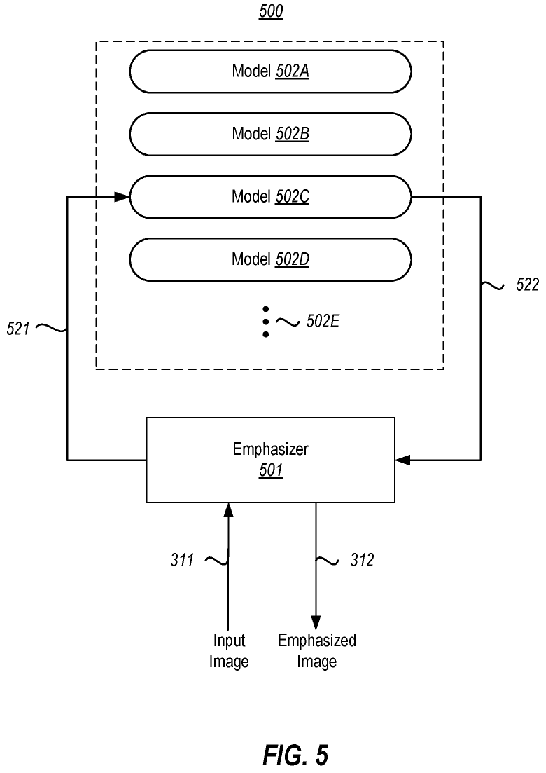

FIG. 5 illustrates an environment 500 that is similar to the environment 300 described above with respect to FIG. 3. However, instead of a single machine-learned model 302, the environment 500 includes multiple machine-learned models 502. In the example of FIG. 5, there are four machine-learned models 502A through 502D. However, the ellipsis 502E represents that there may be any number (one or more) of machine-learned models.

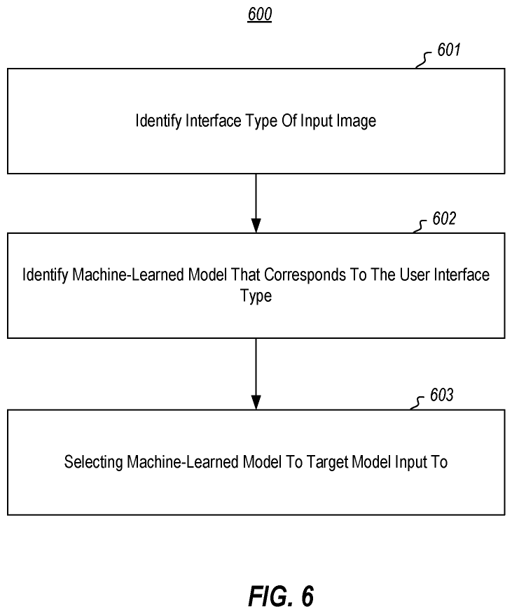

Here, instead of the emphasizer 301 feeding the input image to the machine-learned model 302, the emphasizer 501 feeds (as represented by arrow 521) the input image to the particular machine-learned model 502C. The emphasizer 501 performs the same method 200 described above with respect to the emphasizer 301. However, in the process of feeding the image to the particular machine-learned model 502C, the emphasizer 501 performs the method 600 of FIG. 6.

In particular, the emphasizer 501 determines that the input image corresponds to a user interface type (act 601), determines that the particular machine-learned model (e.g., the machine-learned model 502C) corresponds to the user interface type (act 602), and in response selects the particular machine-learned model as the model to which the model input is to be fed (act 603). Then, referring to FIG. 5, the emphasizer provides (as represented by arrow 521) the model input to the selected particular machine-model 502C, and accesses (as represented by arrow 522) the resulting model output. In one embodiment, the emphasizer 501 is a machine-learned model that is trained to determine a user interface type that an input image corresponds to. Alternatively, the input image may be created with a label that specifies the user interface type that the input image corresponds to.

Accordingly, the principles described herein provide an effective mechanism to automatically generate an emphasis image of an input image, allowing for focus on relevant portions of the input image that are most relevant to an objective. Because the principles described herein are performed in the context of a computing system, some introductory discussion of a computing system will be described with respect to FIG. 7. Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 7, in its most basic configuration, a computing system 700 includes at least one hardware processing unit 702 and memory 704. The processing unit 702 includes a general-purpose processor. Although not required, the processing unit 702 may also include a field programmable gate array (FPGA), an application specific integrated circuit (ASIC), or any other specialized circuit. In one embodiment, the memory 704 includes a physical system memory. That physical system memory may be volatile, non-volatile, or some combination of the two. In a second embodiment, the memory is non-volatile mass storage such as physical storage media. If the computing system is distributed, the processing, memory and/or storage capability may be distributed as well.

The computing system 700 also has thereon multiple structures often referred to as an “executable component”. For instance, the memory 704 of the computing system 700 is illustrated as including executable component 706. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods (and so forth) that may be executed on the computing system. Such an executable component exists in the heap of a computing system, in computer-readable storage media, or a combination.

One of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 704 of the computing system 700. Computing system 700 may also contain communication channels 708 that allow the computing system 700 to communicate with other computing systems over, for example, network 710.

While not all computing systems require a user interface, in some embodiments, the computing system 700 includes a user interface system 712 for use in interfacing with a user. The user interface system 712 may include output mechanisms 712A as well as input mechanisms 712B. The principles described herein are not limited to the precise output mechanisms 712A or input mechanisms 712B as such will depend on the nature of the device. However, output mechanisms 712A might include, for instance, speakers, displays, tactile output, virtual or augmented reality, holograms and so forth. Examples of input mechanisms 712B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then be eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon computer-executable instructions that are structured such that, if executed by the one or more processors, the computing system would be configured to generate emphasis image that is based on an input image but emphasizes a portion of the input image within an emphasis bounding box, by being configured to do the following in response to accessing an input image:
feeding the input image to a machine-learned model that is trained to label portions of images;
accessing output from the machine-learned model in the form of an identification of a plurality of portions of the input image, each of multiple of the plurality of identified portions of the input image being labelled portions of the input image, the label of each labelled portions generated by the machine-learned model;
using a label of a labelled portion of the multiple labelled portions of the input image to determine an emphasis bounding box; and
applying the emphasis bounding box to the input image to generate the emphasis image.

2. The computing system in accordance with claim 1, the computer-executable instructions being are structured such that, if executed by the one or more processors, the computing system is configured such that the emphasis bounding box is a cropping bounding box, and applying the emphasis bounding box to the input image comprises cropping the input image using the cropping bounding box.

3. The computing system in accordance with claim 1, wherein a label of a labelled portion of the multiple labelled portions indicates a relevance of the labelled portion.

4. The computing systems in accordance with claim 1, wherein a label of a labelled portion of the multiple labelled portions indicates a content identity of the labelled portion.

5. The computing system in accordance with claim 1, the using of the label to determine an emphasis boundary box being used in conjunction with user-entered text to identify the emphasis boundary.

6. The computing system in accordance with claim 5, the input image being a screenshot taken by a user, the user-entered text being user feedback representing a user-perceived problem in a user interface represented in the screenshot.

7. The computing system in accordance with claim 1, the using of the label to determine an emphasis boundary box being used in conjunction with a log portion to identifying the emphasis boundary box.

8. The computing system in accordance with claim 7, the input image being a screenshot of a user interface in a particular state, and the log portion represents the log of a system that facilitates generation of the screenshot taken when the user interface was in the particular state.

9. The computing system in accordance with claim 1, the input image being a still image.

10. The computing system in accordance with claim 1, the input image being a video image.

11. The computing system in accordance with claim 1, the computer-executable instructions being are structured such that, if executed by the one or more processors, the computing system is configured such that applying the emphasis bounding box to the input image comprises blackening the input image outside of the cropping bounding box.

12. The computing system in accordance with claim 1, the computer-executable instructions being are structured such that, if executed by the one or more processors, the computing system is configured such that applying the emphasis bounding box to the input image comprises pixelating the input image outside of the cropping bounding box.

13. The computing system in accordance with claim 1, the computer-executable instructions being are structured such that, if executed by the one or more processors, the computing system is configured such that applying the emphasis bounding box to the input image comprises blurring the input image outside of the cropping bounding box.

14. The computing system in accordance with claim 1, the machine-learned model being a particular machine-learned model, the computer-executable instructions including a plurality of machine-learned models, each corresponding to a respective user interface type, one of the plurality of machine-learned models being the particular machine-learned model, the computer-executable instructions being are structured such that, if executed by the one or more processors, the computing system is configured such that feeding the input image to the particular machine-learned model that is trained to label portions of images comprises:
identifying that the input image corresponds to a user interface type;
determining that the particular machine-learned model corresponds to the user interface type; and
in response to the determination, selecting the particular machine-learned model from amongst the plurality of machine-learned models, the feeding of the input image to the particular machine-learned model being in response to the selection.

15. The computing system in accordance with claim 1, the machine-learned model being a particular machine-learned model, the computer-executable instructions including a plurality of machine-learned models, each corresponding to a respective user interface type, the user interface types being defined at least based on an application identity.

16. The computing system in accordance with claim 1, the machine-learned model being a particular machine-learned model, the computer-executable instructions including a plurality of machine-learned models, each corresponding to a respective user interface type, the user interface types being defined at least based on an application user interface context identity.

17. The computing system in accordance with claim 1, the machine-learned model being a particular machine-learned model, the computer-executable instructions including a plurality of machine-learned models, each corresponding to a respective user interface type, the user interface types being defined at least based on a version of an application.

18. The computing system in accordance with claim 1, the machine-learned model being a particular machine-learned model, the computer-executable instructions including a plurality of machine-learned models, each corresponding to a respective user interface type, the user interface types being defined at least based on screen size.

19. A computer-implemented method for generating an emphasis image that is based on an input image but emphasizes a portion of the input image within an emphasis bounding box, by being configured to do the following in response to access an input image and determining that the input image is to be cropped:
identifying that the input image corresponds to a user interface type;
determining that the machine-learned model corresponds to the user interface type,
in response to the determination, selecting the particular machine-learned model from amongst a plurality of machine-learned models;
in response to the selection, the feeding of the input image to the particular machine-learned model being in response to the selection;
accessing output from the particular machine-learned model in the form of an identification of a plurality of portions of the input image, each of multiple of the plurality of identified portions of the input image being labelled portions of the input image, the label of each labelled portions generated by the particular machine-learned model;
using a label of a labelled portion of the multiple labelled portions of the input image to determine an emphasis bounding box; and
applying the emphasis bounding box to the input image to generate the emphasis image.

20. A computer-implemented method for generating a cropped image that is based on an input image, by being configured to do the following in response to access an input image and determining that the input image is to be cropped:
feeding the input image to a machine-learned model that is trained to label portions of images;
accessing output from the machine-learned model in the form of an identification of a plurality of portions of the input image, each of multiple of the plurality of identified portions of the input image being labelled portions of the input image, the label of each labelled portions generated by the machine-learned model;
using a label of a labelled portion of the multiple labelled portions of the input image to determine a cropping boundary; and
applying the cropping boundary to the input image to generate the cropped image.
